(19) United States
(12) Patent Application Publication
(10) Pub. No.: US 2008/0232489 A1
(43) Pub. Date: Sep. 25, 2008

(54) Spatial interleaver for MIMO wireless communication systems

(76) Inventors: Jiannan Tsai, Plano, TX (US); Farooq Khan, Allen, TX (US); Cornelius Van Rensburg, Dallas, TX (US); Zhouyue Pi, Richardson, TX (US); Yinong Ding, Plano, TX (US)

Correspondence Address: ROBERT E. BUSHNELL, 1522 K STREET NW, SUITE 300, WASHINGTON, DC, 20005-1202, US

(21) Appl. No.: 12/007,894

(22) Filed: Jan. 16, 2008

Related U.S. Application Data
(60) Provisional application No. 60/919,618, filed on Mar. 23, 2007.

(51) Int. Cl. H04L 27/28

(52) U.S. Cl. 375/260; 375/295

(57) ABSTRACT

A method for transmission is provided to include demultiplexing information to be transmitted into a plurality of stream blocks, encoding each of the stream blocks according to a corresponding coding scheme to generate a plurality of encoded streams, interleaving the plurality of encoded streams in a bit-level to generate a plurality of bit-level interleaved streams, modulating each of the bit-level interleaved streams according to a corresponding modulation scheme to generate a plurality of modulated symbol streams, interleaving the plurality of modulated symbol streams in a symbol-level to generate a plurality of symbol-level interleaved streams, precoding the plurality of symbol-level interleaved streams according to a precoding scheme to generate a plurality of precoded streams, and transmitting the plurality of precoded streams via a plurality of antennas.

### CLAIM OF PRIORITY

This application makes reference to, incorporates the same herein, and claims all benefits accruing under 35 U.S.C. §119 from a provisional application earlier filed in the U.S. Patent & Trademark Office on 23 Mar. 2007 and there duly assigned Ser. No. 60/919,618.

### BACKGROUND OF THE INVENTION

1. Field of the Invention

The present invention relates to a method for transmitting data in a MIMO wireless communication system, more specifically, a method of spatially interleaving data before data is transmitted.

2. Description of the Related Art

A wireless communication system generally includes multiple base stations and is multiple mobile stations, while a single base station is communicated with a set of mobile stations. The transmission from a base station to a mobile station is known as downlink communication. Likewise, the transmission from a mobile station to a base station is known as uplink communication. Both base stations and mobile stations are employing multiple antennas for transmitting and receiving radio wave signals. The radio wave signal may be Orthogonal Frequency Division Multiplexing (OFDM) signals or Code Division Multiple Access (CDMA) signals. A mobile station may be a PDA, laptop, or handheld device.

A multiple antenna communication system, which is often referred to as multiple input multiple output (MIMO) system, is widely used in combination with OFDM technology, in a wireless communication system to improve system performance.

In a MIMO system, both transmitter and receiver are equipped with multiple antennas. Therefore, the transmitter is capable of transmitting independent data streams simultaneously in the same frequency band. Unlike traditional means of increasing throughput (i.e., the amount of data transmitted per time unit) by increasing bandwidth or increasing overall transmit power, MIMO technology increases the spectral efficiency of a wireless communication system by exploiting the additional dimension of freedom in the space domain due to multiple antennas. Therefore MIMO technology can significantly increase the throughput and range of the system.

In some systems, for example, Third Generation Partnership Project Long Term Evolution (3GPP LTE) systems, the information block size can be very large to support very high data rate while the largest allowable code block size can be much smaller in order to limit the required peak rate processing power to reduce implementation cost and power consumption. In the case of transmissions of large information block size, each information block, which may be one codeword, can be broken up into multiple code blocks. The techniques described here are applicable to multiple code blocks within a codeword, and multiple code blocks from multiple codewords.

In the prior art, a typical channel interleaver can be used to mitigate the burst error in a mobile radio channel for a single transmitted stream systems (or a single codeword system). In a multiple transmitted stream system, a multiple codeword can be employed in multiple transmit antenna and multiple receive antenna systems (known as a MIMO system). Each channel interleaver is generally directly connected to each codeword in MIMO system and each codeword is then mapped to a single spatial layer or multiple spatial layers that are different from the spatial layers used by other codewords. This scheme may results in performance loss when mapped layers are all in deep fading channel conditions.

### SUMMARY OF THE INVENTION

It is therefore an object of the present invention to provide an improved method and apparatus for data transmission.

It is another object of the present invention to provide an improved method and apparatus for data transmission to increase spatial diversity.

It is still another object of the present invention to enable performance robustness.

According to one aspect of the present invention, a method for transmission may include demultiplexing information to be transmitted into a plurality of stream blocks, encoding each of the stream blocks according to a corresponding coding scheme to generate a plurality of encoded streams, interleaving each of the encoded streams in a bit-level to generate a plurality of bit-level interleaved streams, modulating each of the bit-level interleaved streams according to a corresponding modulation scheme to generate a plurality of modulated symbol streams, interleaving the plurality of modulated symbol streams in a symbol-level to generate a plurality of symbol-level interleaved streams, precoding the plurality of symbol-level interleaved streams according to a precoding scheme to generate a plurality of precoded streams, and transmitting the plurality of precoded streams via a plurality of antennas.

The step of interleaving the plurality of modulated symbol streams in the symbol-level may include multiplexing the plurality of modulated symbol streams to generate a single stream, and equally dividing the single stream into the plurality of symbol-level interleaved streams, with the number of the plurality of symbol-level interleaved streams being equal to the number of the antennas for transmitting the streams.

Alternatively, the step of interleaving the plurality of modulated symbol streams in the symbol-level may include multiplexing the plurality of modulated symbol streams to generate a single stream, mapping the single stream into an N×M matrix in a column-wise manner, with each symbol in the single stream corresponding to one element in the N×M matrix, and B=N×M, where B is the number of the symbols in the single stream, reading the symbols in the N×M matrix in a row-wise manner and concatenating the symbols to generate a single symbol-level interleaved stream, and equally dividing the single symbol-level interleaved stream into the plurality of symbol-level interleaved streams, with the number of the plurality of symbol-level interleaved streams being equal to the number of the antennas for transmitting the streams.

Still alternatively, the step of interleaving the plurality of modulated symbol streams in the symbol-level may include multiplexing the plurality of modulated symbol streams to generate a single stream, randomly rearranging the symbols in the single stream according to a random function to generate a single symbol-level interleaved stream, and equally dividing the single symbol-level interleaved stream into the plurality of symbol-level interleaved streams, with the number of the plurality of symbol-level interleaved streams being equal to the number of the antennas for transmitting the streams. It is noted that the random function can be, for example, uniform distributed function.

Each of the encoded streams may be interleaved in the bit-level by mapping the bits in the encoded stream into an N×M matrix in a column-wise manner, with each bit corresponding to one element in the N×M matrix, and B=N×M, where B is the number of the bits in the encoded stream, reading the bits in the N×M matrix in a row-wise manner and concatenating the bits to generate a single bit-level interleaved stream.

According to another aspect of the present invention, A method for transmission may include demultiplexing information to be transmitted into a plurality of stream blocks, encoding each of the stream blocks according to a corresponding coding scheme to generate a plurality of encoded streams, interleaving the plurality of encoded streams in a bit-level to generate a plurality of bit-level interleaved streams, modulating each of the bit-level interleaved streams according to a modulation scheme to generate a plurality of modulated symbol streams, precoding the plurality of modulated symbol streams according to a precoding scheme to generate a plurality of precoded streams, and transmitting the plurality of precoded streams via a plurality of antennas.

The step of interleaving the plurality of encoded streams in the bit-level may include multiplexing the plurality of encoded streams to generate a single stream, and equally dividing the single stream into the plurality of bit-level interleaved streams, with the number of the plurality of bit-level interleaved streams being equal to the number of the antennas for transmitting the streams.

Alternatively, the step of interleaving the plurality of encoded streams in the bit-level may include multiplexing the plurality of encoded streams to generate a single stream, mapping the single stream into an N×M matrix in a column-wise manner, with each bit in the single stream corresponding to one element in the N×M matrix, and B=N×M, where B is the number of the bits in the single stream, reading the bits in the N×M matrix in a row-wise manner and concatenating the bits to generate a single bit-level interleaved stream, and equally dividing the single bit-level interleaved stream into the plurality of bit-level interleaved streams, with the number of the plurality of bit-level interleaved streams being equal to the number of the antennas for transmitting the streams.

Still alternatively, the step of interleaving the plurality of encoded streams in the bit-level may include multiplexing the plurality of encoded streams to generate a single stream, randomly rearranging the bits in the single stream according to a random function to generate a single bit-level interleaved stream, and equally dividing the single bit-level interleaved stream into the plurality of bit-level interleaved streams, with the number of the plurality of bit-level interleaved streams being equal to the number of the antennas for transmitting the streams.

According to yet another aspect of the present invention, a method for transmission may include demultiplexing information to be transmitted into a plurality of stream blocks, encoding each of the stream blocks according to a corresponding coding scheme to generate a plurality of encoded streams, modulating each of the encoded streams according to a corresponding modulation scheme to generate a plurality of modulated symbol streams, interleaving the plurality of modulated symbol streams in a symbol-level to generate a plurality of symbol-level interleaved streams, precoding the plurality of symbol-level interleaved streams according to a precoding scheme to generate a plurality of precoded streams, and transmitting the plurality of precoded streams via a plurality of antennas.

According to still another aspect of the present invention, a method for transmission may include demultiplexing information to be transmitted into a plurality of stream blocks, encoding each of the stream blocks according to a corresponding coding scheme to generate a plurality of encoded streams, interleaving the plurality of encoded streams in a bit-level to generate a plurality of bit-level interleaved streams, modulating each of the bit-level interleaved streams according to a corresponding modulation scheme to generate a plurality of modulated symbol streams, interleaving the plurality of modulated symbol streams in a symbol-level to generate a plurality of symbol-level interleaved streams, precoding the plurality of symbol-level interleaved streams according to a precoding scheme to generate a plurality of precoded streams, and transmitting the plurality of precoded streams via a plurality of antennas.

According to still yet another aspect of the present invention, a transmitter may be constructed with a demultiplexer demultiplexing information to be transmitted into a plurality of stream blocks, a plurality of cyclic redundancy check insertion units respectively inserting respective cyclic redundancy checks to the corresponding stream blocks, a plurality of encoding units respectively encoding corresponding ones of the stream blocks according to corresponding coding schemes to generate a plurality of encoded streams, a plurality of channel bit interleavers respectively interleaving corresponding ones of the encoded streams in a bit-level to generate a plurality of bit-level interleaved streams, a plurality of modulators modulating respectively corresponding ones of the bit-level interleaved streams according to corresponding modulation schemes to generate a plurality of modulated symbol streams, a symbol-level spatial interleaver interleaving the plurality of modulated symbol streams in a symbol-level to generate a plurality of symbol-level interleaved streams, a precoding unit precoding the plurality of symbol-level interleaved streams according to a precoding scheme to generate a plurality of precoded streams, and a plurality of antennas for transmitting the plurality of precoded streams.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates a wireless communication system;

FIG. 2 illustrates an Orthogonal Frequency-Division Multiplexing (OFDM) transceiver chain;

FIG. 3 illustrates a Multiple Input Multiple Output (MIMO) transmitting and receiving scheme;

FIG. 4 illustrates a single-codeword MIMO-OFDM scheme;

FIG. 5 illustrates a multiple-codeword MIMO-OFDM Per Antenna Rate Control (PARC) scheme;

FIG. 6 illustrates the basic operation of a channel bit interleaver;

FIG. 7 illustrates an example of a channel bit interleaver;

FIG. 8 illustrates a multiple-codewords MIMO-OFDM system according to a first embodiment of the principles of the present invention;

FIG. 9 illustrates a symbol-level spatial interleaver according to the first embodiment of the principles of the present invention;

FIG. 10 illustrates a symbol-level spatial interleaver according to a second embodiment of the principles of the present invention;

FIG. 11 illustrates a symbol-level spatial interleaver according to a third embodiment of the principles of the present invention;

FIG. 12 illustrates a multiple-codewords MIMO-OFDM system according to a fourth embodiment of the principles of the present invention;

FIG. 13 illustrates a bit-level spatial interleaver according to the fourth embodiment of the principles of the present invention;

FIG. 14 illustrates a bit-level spatial interleaver according to a fifth embodiment of the principles of the present invention;

FIG. 15 illustrates a bit-level spatial interleaver according to a sixth embodiment of the principles of the present invention;

FIG. 16 illustrates a multiple-codewords MIMO-OFDM system according to a seventh embodiment of the principles of the present invention;

FIG. 17 illustrates a multiple-codewords MIMO-OFDM system according to an eighth embodiment of the principles of the present invention;

FIG. 18 illustrates block error rate (BLER) simulation results of the proposed schemes compared with the PARC scheme with QAM-64 modulation;

FIG. 19 illustrates block error rate (BLER) simulation results of the proposed schemes compared with the PARC scheme with QAM-16 modulation;

FIG. 19 illustrates block error rate (BLER) simulation results of the proposed schemes compared with the PARC scheme with QAM-64 modulation; and

FIG. 20 illustrates block error rate (BLER) simulation results of the proposed schemes compared with the PARC scheme with QPSK modulation.

### DETAILED DESCRIPTION OF THE INVENTION

Aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive. The invention is illustrated by way of example, and not by way of limitation, in the accompanying drawings.

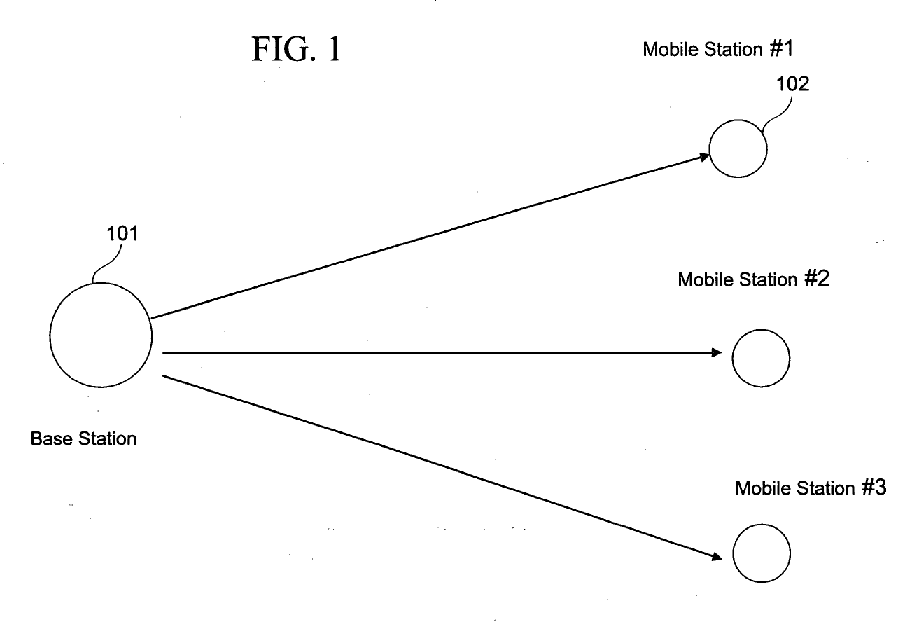

Various embodiments according to the principles of the present invention can be implemented in a communication system as shown in FIG. 1, where a base station 101 is communicated with multiple mobile stations 102. The transmission from base station 101 to mobile station 102 is known as downlink communication. Likewise, the transmission from mobile station 102 to base station 101 is known as uplink communication. Both base station 101 and mobile stations 102 are employing multiple antennas for transmitting and receiving radio wave signals. The radio wave signal may be Orthogonal Frequency Division Multiplexing (OFDM) signals or Code Division Multiple Access (CDMA) signals. A mobile station may be a PDA, laptop, or handheld device.

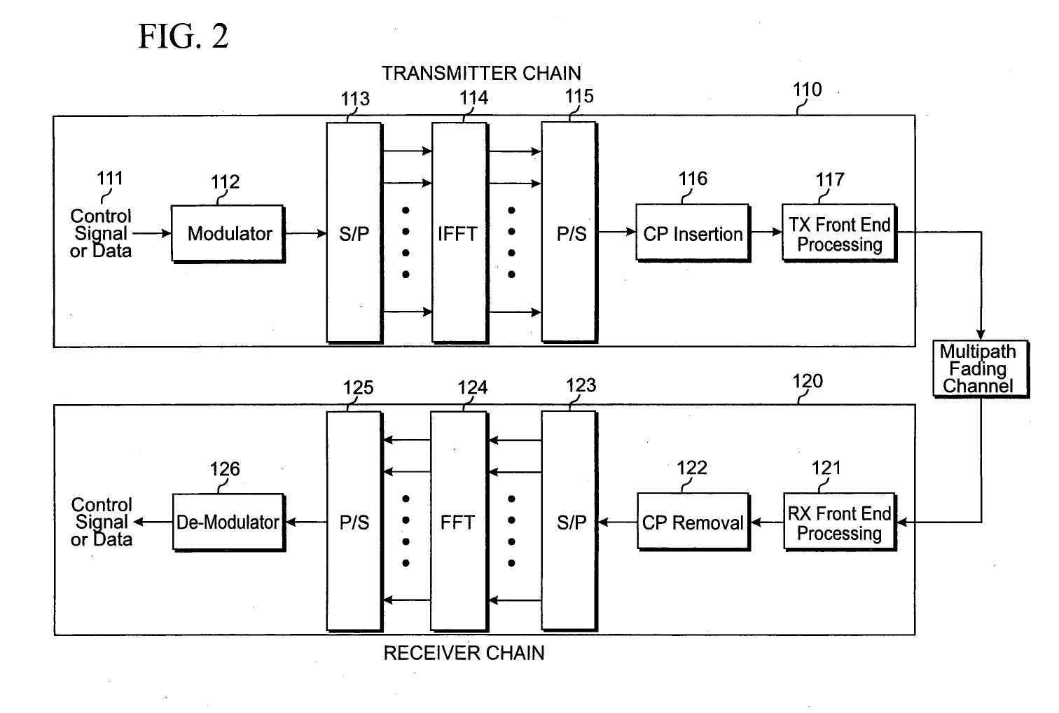

FIG. 2 illustrates an Orthogonal Frequency Division Multiplexing (OFDM) transceiver (i.e., a transmitter and a receiver) chain. In a communication system using OFDM technology, at transmitter chain 110, control signals or data 111 is modulated by modulator 112 and is serial-to-parallel converted by Serial/Parallel (S/P) converter 113. Inverse Fast Fourier Transform (IFFT) unit 114 is used to transfer the signal from frequency domain to time domain. Cyclic prefix (CP) or zero prefix (ZP) is added to each OFDM symbol by CP insertion unit 116 to avoid or mitigate the impact due to multipath fading. Consequently, the signal is transmitted by transmitter (Tx) front end processing unit 117, such as an antenna (not shown), or alternatively, by fixed wire or cable. At receiver chain 120, assuming perfect time and frequency synchronization are achieved, the signal received by receiver (Rx) front end processing unit 121 is processed by CP removal unit 122. Fast Fourier Transform (FFT) unit 124 transfers the received signal from time domain to frequency domain for further processing.

The total bandwidth in an OFDM system is divided into narrowband frequency units called subcarriers. The number of subcarriers is equal to the FFT/IFFT size N used in the system. In general, the number of subcarriers used for data is less than N because some subcarriers at the edge of the frequency spectrum are reserved as guard subcarriers. In general, no information is transmitted on guard subcarriers.

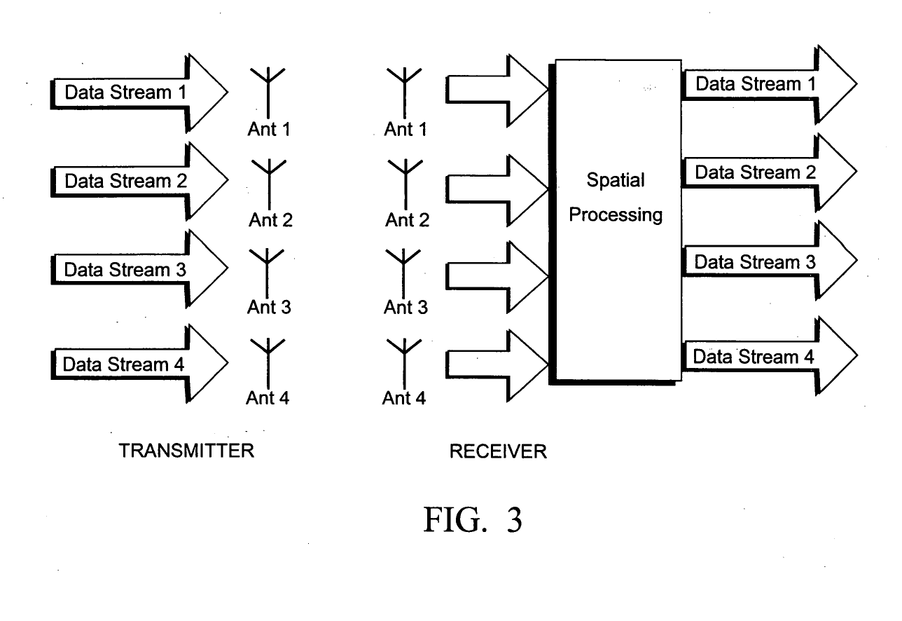

Multiple Input Multiple Output (MIMO) schemes use multiple transmit antennas and multiple receive antennas to improve the capacity and reliability of a wireless communication channel. A MIMO system promises linear increase in capacity with K where K is the minimum of number of transmit (M) and receive antennas (N), i.e. K=min(M,N). A simplified example of a 4×4 MIMO system is shown in FIG. 3. In this example, four different data streams are transmitted separately from the four transmission antennas. The transmitted signals are received at the four reception antennas. Some form of spatial signal processing is performed on the received signals in order to recover the four data streams. An example of spatial signal processing is vertical Bell Laboratories Layered Space-Time (V-BLAST) which uses the successive interference cancellation principle to recover the transmitted data streams. Other variants of MIMO schemes include schemes that perform some kind of space-time coding across the transmit antennas (e.g., diagonal Bell Laboratories Layered Space-Time (D-BLAST)) and also beamforming schemes such as Spatial Division multiple Access (SDMA).

The MIMO channel estimation consists of estimating the channel gain and phase information for links from each of the transmit antennas to each of the receive antennas. Therefore, the channel for M×N MIMO system consists of an N×M matrix:

$$H = [ \begin{matrix}{a}_{11} & {a}_{12} & ⋯ & {a}_{1 M} \\ {a}_{21} & {a}_{22} & ⋯ & {a}_{2 M} \\ ⋮ & ⋮ & ⋯ & ⋮ \\ {a}_{N 1} & {a}_{M 2} & ⋯ & {a}_{NM}\end{matrix} ] \qquad ( 1 )$$

where aᵢⱼ represents the channel gain from transmit antenna j to receive antenna i. In order to enable the estimations of the elements of the MIMO channel matrix, separate pilots are transmitted from each of the transmit antennas.

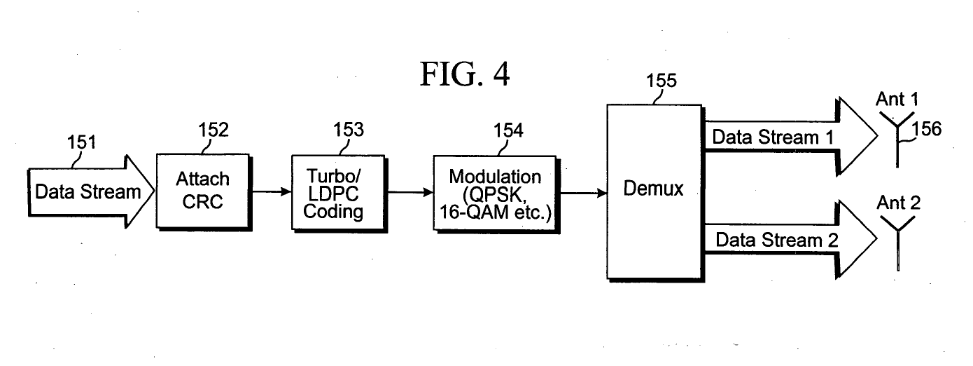

An example of a single-code word MIMO scheme is given in FIG. 4. In case of single-code word MIMO transmission, a cyclic redundancy check (CRC) 152 is added to a single data stream 151 and then coding 153 and modulation 154 are sequentially performed. The coded and modulated symbols are then demultiplexed 155 for transmission over multiple antennas 156.

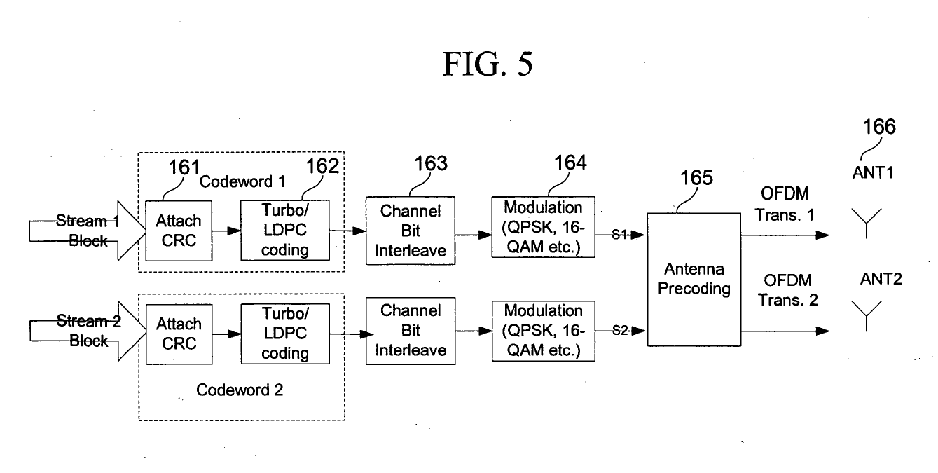

In case of multiple-code word MIMO transmission, shown in FIG. 5, the information block is first demultiplexed into smaller information blocks. Individual CRCs are attached to these smaller information blocks by a CRC attachment unit 161. Then separate coding by coding units 162, interleaving by channel bit interleavers 163, and modulation by modulation units 164 are performed on these smaller blocks. These smaller information blocks are precoded by an antenna precoding unit 165 and then transmitted from separate MIMO antennas 166 or beams. It should be noted that in case of multiple-code word MIMO transmissions, different modulation and coding can be used on each of the individual streams resulting in a so-called Per Antenna Rate Control (PARC) scheme. Also, multiple-code word transmission enables more efficient post-decoding interference cancellation because a CRC check can be performed on each of the code words before the code word is cancelled from the overall signal. In this way, only correctly received code words are cancelled, thus avoiding any interference propagation in the cancellation process.

In some systems, e.g., Third Generation Partnership Project Long Term Evolution (3GPP LTE) systems, the information block size can be very large to support very high data rate while the largest allowable code block size can be much smaller in order to limit the required peak rate processing power to reduce implementation cost and power consumption. In the case of transmissions of large information block size, each information block, which may be one codeword, can be broken up into multiple code blocks. The techniques described here are applicable to multiple code blocks within a codeword, and multiple code blocks from multiple codewords. For example, the streams described in the FIG. 5 may represent information bits and coded bits of code blocks from the same codeword in this case. Note, also in this case, the streams described in FIG. 5 can certainly represent information bits and coded bits of code blocks from different codewords.

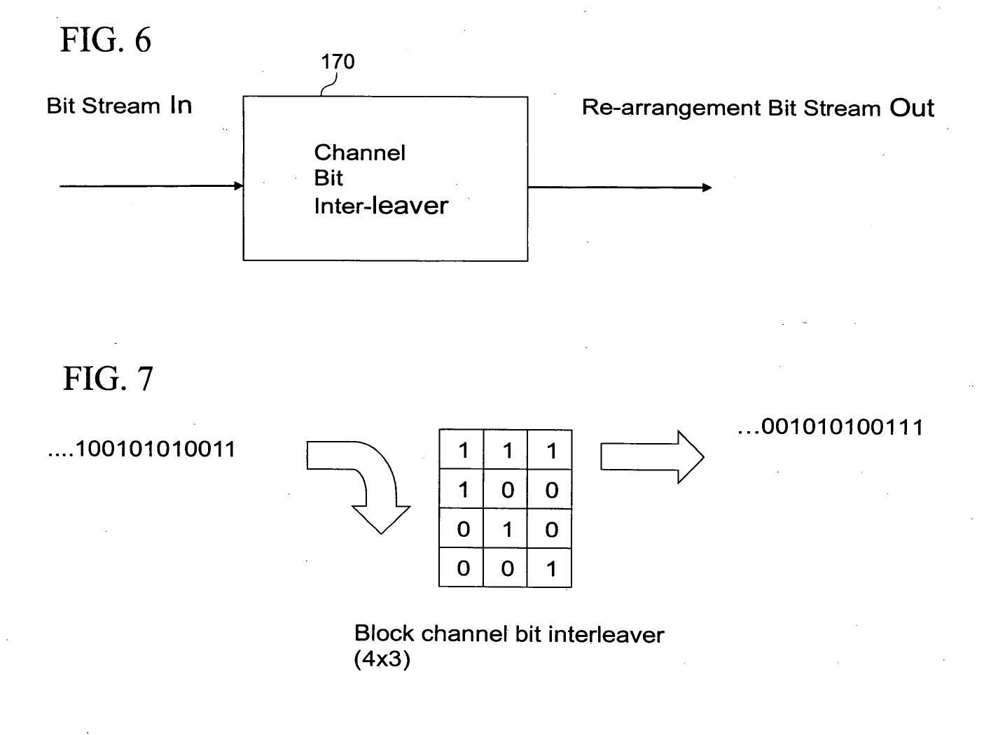

FIG. 6 illustrates the detail operation of a channel bit interleaver. A bit stream from a Turbo/LDPC coding block is input into a Channel bit interleaver 170. Then through a certain bit stream re-arrangement method, the bit stream at the output of channel bit interleaver is re-arranged.

As an example, FIG. 7 illustrates a scheme that an input bit stream is re-arranged through a block channel bit interleaver. In this example, a block channel interleaver with the size of 4×3 is used. The block interleaver takes a bit stream sequence with a length of twelve (12) at a time and is arranged in a column-by-column manner. At the output of the block interleaver, the bit sequence is read out in a row-by-row manner. With such operation, the input bit stream “100101010011” is re-arranged as “001010100111” and re-distributed. Therefore, at the receiver, the burst error due to mobile radio channel can be scattered and randomized, thus improving performance.

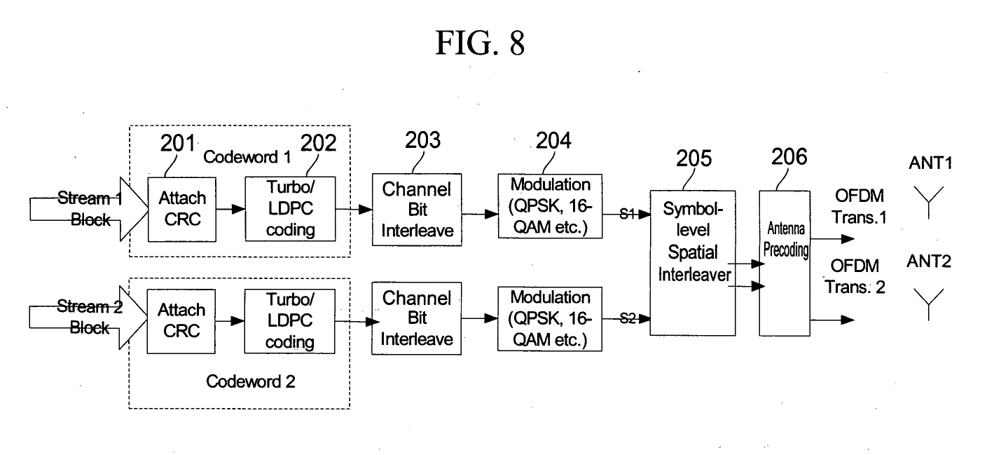

FIG. 8 illustrates a block diagram of a multiple-codeword MIMO-OFDM system according to a first embodiment of the principles of the present invention. The spatial interleaving scheme shown in FIG. 8 is denoted as Scheme-A. The basic block diagram on coding, modulation, and channel bit interleaver schemes is the same as the PARC scheme as shown in FIG. 5. A symbol-level spatial channel interleaver 205 is, however, proposed to be coupled between antenna precoding unit 206 and modulation unit 204. As an example in FIG. 8, a two-codeword MIMO system with two transmission antennas is presented. The spatial channel interleaver allows modulation symbols S1 (from codeword 1) and S2 (from codeword 2) to be transmitted on two spatial layer when rank-2 transmission is active, thus each codeword (codeword 1 or codeword 2) would experience two layers of spatial channel, thereby the proposed scheme would increases spatial diversity. In addition, the proposed scheme provides performance robustness in the case of Channel Quality Indicator (CQI) error. Symbol-level spatial channel interleaver 205 takes a stream of modulated symbols such as QPSK symbols, QAM-16 symbols, and QAM-64 symbols from modulation unit 204 as its input. Then through a symbol stream re-arrangement method, the symbols at the output of the spatial channel interleaver is rearranged and re-distributed.

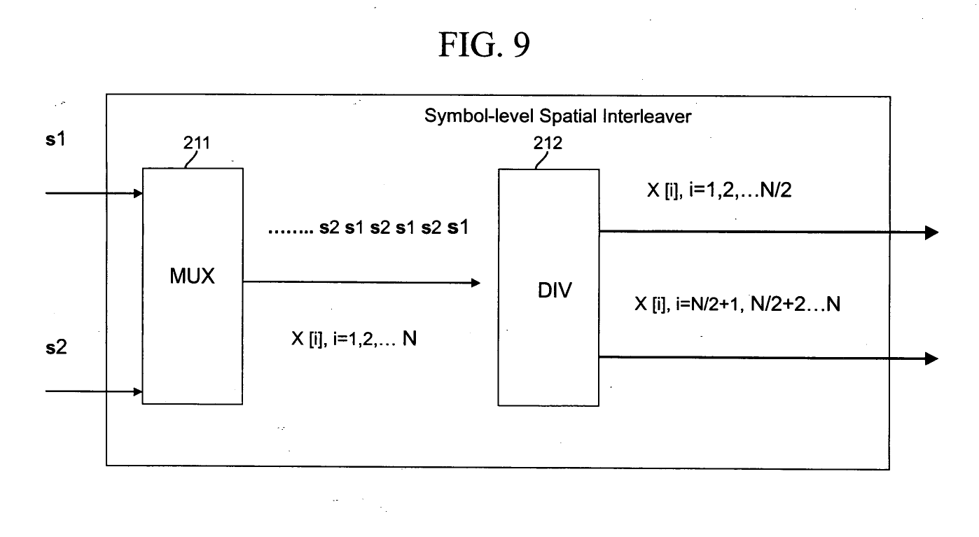

In the first embodiment of the present invention, FIG. 9 illustrates a method for a symbol-level spatial channel interleaver to re-arrange the modulated symbols from S1 (from. codeword 1) and S2 (from codeword 2). As shown in FIG. 9, S1 and S2 are multiplexed by multiplexing unit (MUX) 211 to form a single symbol stream X[i], i=1,2, . . . N, where N is the total modulated symbols generated from both codeword 1 and codeword 2. The multiplexed stream is then equally divided by dividing unit (DIV) 212 into two separated streams. Each of the divided symbol stream is then sent to a single spatial layer. It is noted that the spatial layer is defined by antenna precoding (AP) unit 206 as illustrated in FIG. 8. For example, an AP unit with two transmission antennas can perform two-spatial-layer transmission when rank-2 transmission is active. The first divided symbol stream X[i], i=1,2, . . . N/2, is mapped to layer-1; the second divided symbol stream X[i], i=N/2+1, N/2+2, . . . N is mapped to layer 2. We denoted this type of symbol-level spatial interleaver as Symbol-level Spatial Interleaver-X.

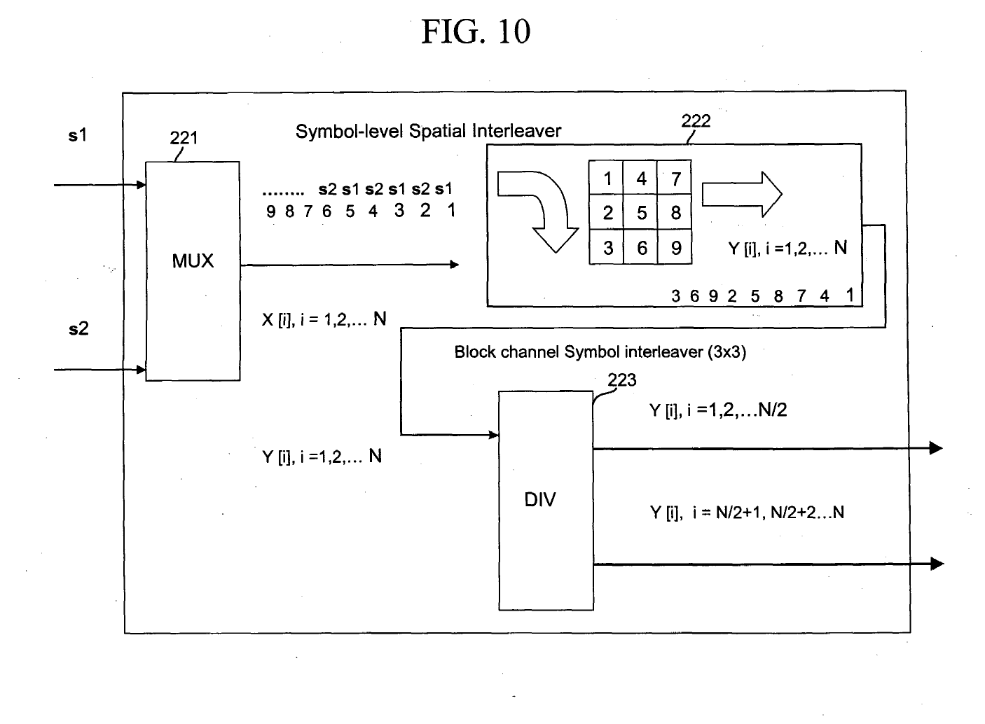

FIG. 10 illustrates another example of symbol-level spatial interleaver according to a second embodiment of the principles of the present invention. In this embodiment, the modulated symbols from S1 (from codeword 1) and S2 (from codeword 2) are multiplexed by multiplexing unit (MUX) 221 to form a single symbol stream X[i], i=1,2, . . . N. The multiplexed stream X[i], i=1,2, . . . N, is further interleaved by block channel symbol interleaver 222. In this embodiment, because the size of block channel symbol interleaver 222 is 3×3, thus N=9. As shown in FIG. 10, the multiplexed stream X[i] with the original sequence order 1, 2, 3, . . . N is re-arranged by block channel symbol interleaver 222. Block channel symbol interleaver 222 reads the multiplexed stream X[i] and stores the symbols in a buffer in a column-wise manner. Subsequently, the symbols are read out from block channel symbol interleaver 222 in a row-wise manner. The interleaved stream has a new sequence order of 1, 4, 7, 8, 5, 2, 9, 6, 3. Above is an example for the block channel symbol interleaver according to the principles of the present invention. Embodiments implementing the principles of the present invention, however, are not limited to this example. For example, the multiplexed stream may be written into the block channel symbol interleaver in a row-wise manner, and read out from the block channel symbol interleaver in a column-wise manner. The interleaved sequenced is denoted as Y[i], i=1, 2, . . . N and then is equally divided by dividing unit (DIV) 212 into two separated symbol streams Y[i], i=1, 2, . . . N/2 and Y[i], i=N/2+1, N/2+2, . . . , N. Each of the divided symbol stream is then transmitted to a single spatial layer. We denoted this type of symbol-level spatial interleaver as Symbol-level Spatial Interleaver-Y. As for comparison, Symbol-level Spatial Interleaver-X is more determined and structured while Symbol-level Spatial Interleaver-Y is more random and un-structured.

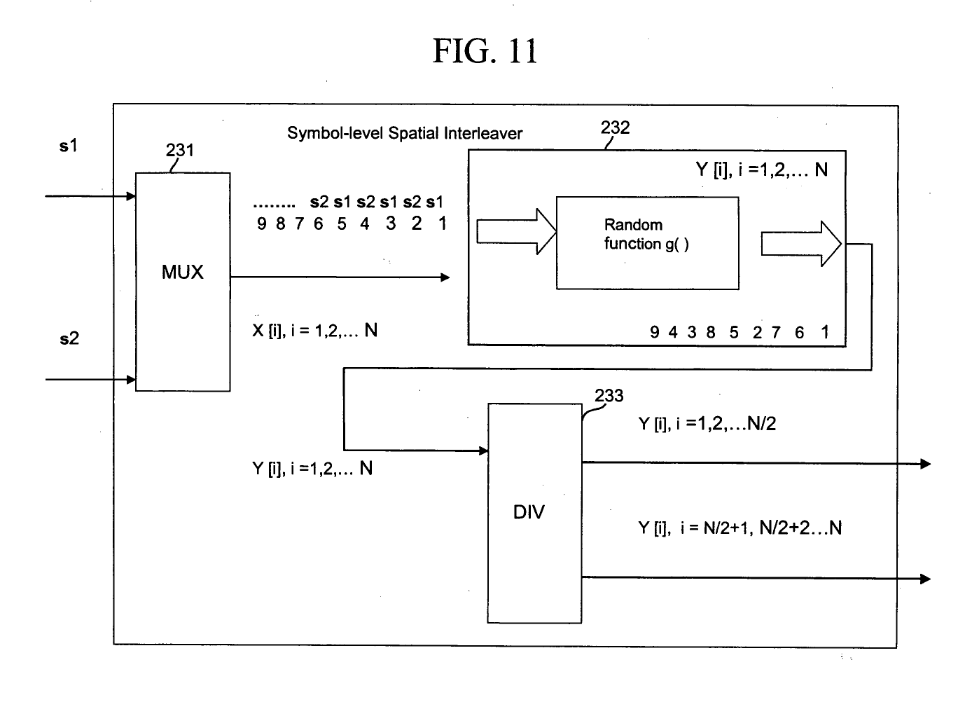

FIG. 11 illustrates a third type of symbol-level spatial interleaver according to a third embodiment of the principles of the present invention. This third type of symbol-level spatial interleaver is denoted as Symbol-level Spatial Interleaver-Z, and is even more random. In this embodiment, block channel symbol interleaver 222 in FIG. 10 is replaced by random function interleaver 232. This random function is used to generate a random index that can be use to shuffle the stream X[i]. That is, the stream Y[i], i=1, 2, . . . N, is a shuffled version of X[i], i=1, 2, . . . N in a random manner.

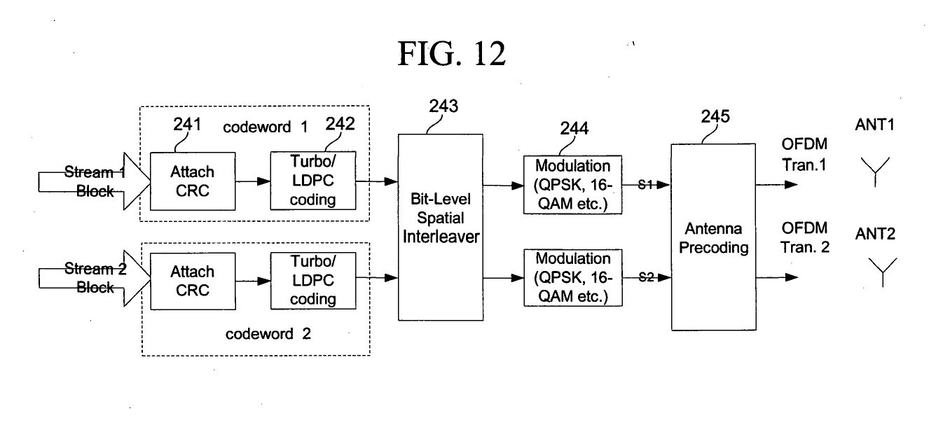

FIG. 12 illustrates a block diagram of another proposed spatial interleaver scheme (denoted as Scheme-B) for multi-codeword MIMO-OFDM systems according to a fourth embodiment of the principles of the present invention. The basic block diagram on coding, modulation, and channel bit interleaver schemes are the same as the PARC scheme as shown in FIG. 5. A bit-level spatial channel interleaver 243 is, however, proposed to be coupled between coding unit 242 and modulation unit 244. As an example in FIG. 5, a two-codeword MIMO, system with two transmission antennas is presented. Bit-level spatial channel interleaver 243 allows the bit streams from codeword 1 and codeword 2 to be transmitted on two spatial layers when rank-2 transmission is active, thus each codeword (codeword 1 or codeword 2) would experience two layers of spatial channel, thereby increasing a spatial diversity. In addition, the proposed scheme enables performance robustness in the presence of CQI error.

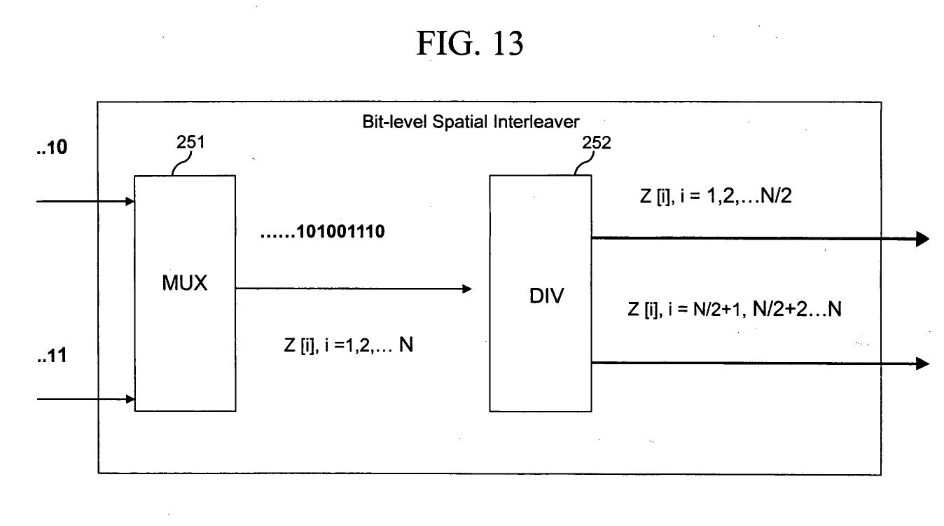

FIG. 13 illustrates an example for bit-level spatial channel interleaver 243 to re-arrange the bit streams from codeword 1 and codeword 2 according to the fourth embodiment of the principles of the present invention. As shown, the bit streams from codeword 1 and codeword 2 are multiplexed by multiplexing unit (MUX) 251 to form a single symbol stream Z[i], i=1, 2, . . . N. The multiplexed stream is then equally divided by divining unit (DIV) 252 into two separated streams Z[i], i=1, 2, . . . N/2 and Z[i], i=N/2+1, N/2+2, . . . N. Each of the divided bit stream is then transmitted to corresponded modulation unit 244 as shown in FIG. 12. We denoted this type of bit spatial interleaver as Bit-Level Spatial Interleaver-X. The modulated symbols S1 and S2 are further transmitted to a single spatial layer. It is noted that the spatial layer is defined by antenna preceding unit 245 as shown in FIG. 12.

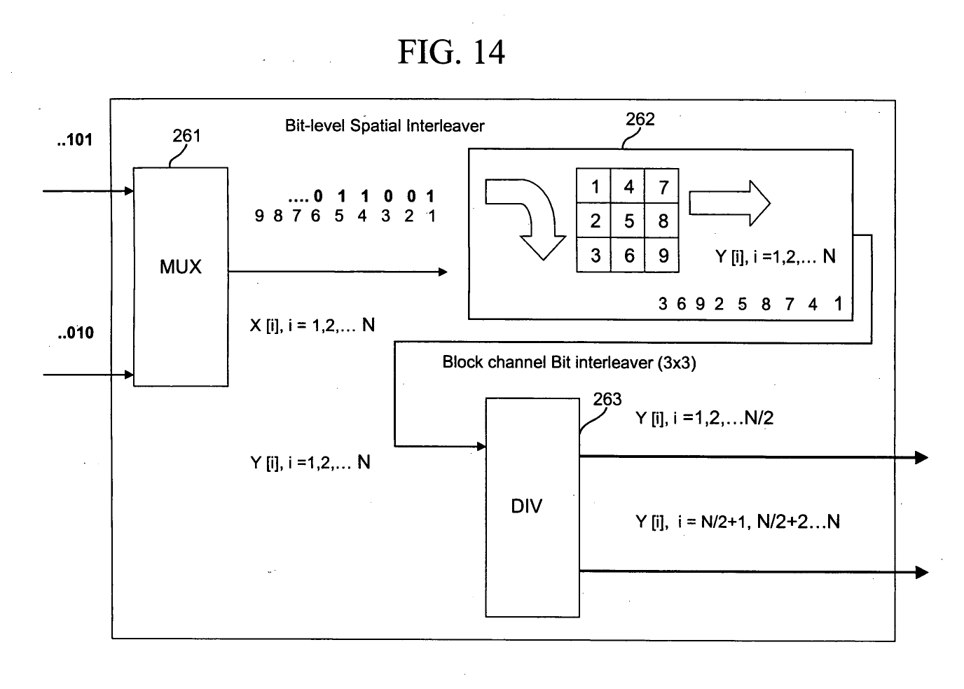

FIG. 14 illustrates another example of bit-level spatial interleaver according to a fifth embodiment of the principles of the present invention. In this case, the multiplexed stream X[i], i=1, 2, . . . N, is further interleaved by block channel bit interleaver 262. Because the size of the block channel bit interleaver is 3×3, thus N=9. As shown in FIG. 14, the stream X[i] with the original sequence order 1, 2, 3 . . . N is re-arranged by block channel bit interleaver 262. The interleaved stream has a new sequence-order of 1, 4, 7, 8, 5, 2, 9, 6, 3. The interleaved sequenced is denoted as Y[i], i=1, 2, . . . N, and then is equally divided into two separated bit streams Y[i], i=1, 2, . . . N/2 and Y[i], i=N/2+1, N/2+2, . . . , N. Each of the divided symbol stream is then transmitted to a single spatial layer. We denoted this type of bit-level spatial interleaver as Bit-level Spatial Interleaver-Y. As for comparison, bit-level spatial interleaver-X is more determined and structured while bit-level spatial interleaver-Y is more random and un-structured.

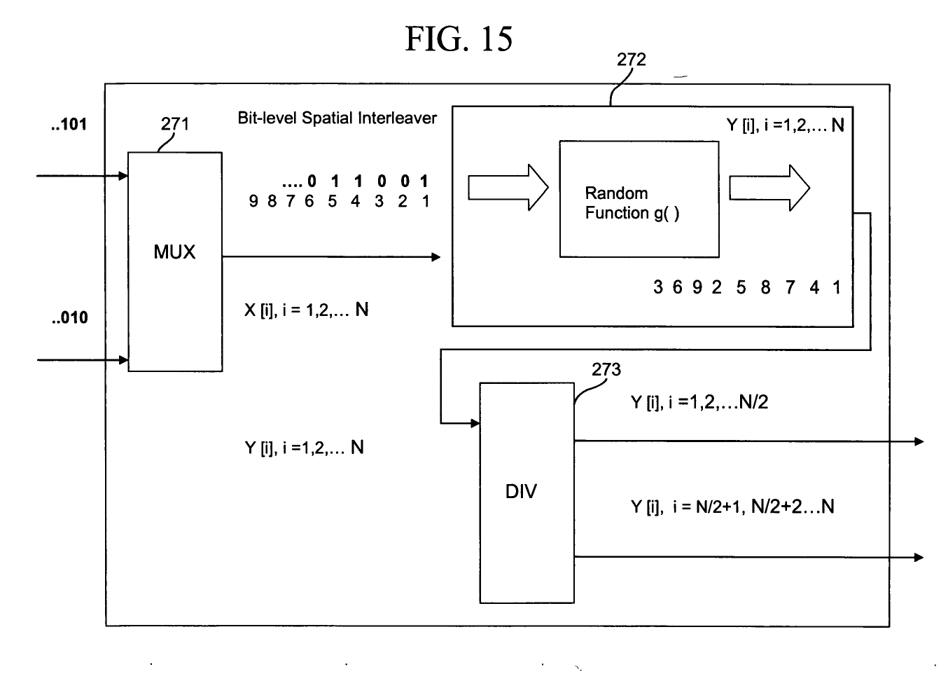

FIG. 15 illustrates a third type of bit-level spatial interleaver according to a sixth embodiment of the principles of the present invention. This bit-level spatial interleaver is denoted as Bit-level Spatial Interleaver-Z and is even more random then Bit-level Spatial Interleaver-Y. As compared to Bit-level Spatial Interleaver-Y in FIG. 14, block channel bit interleaver 262 is replaced by a random function interleaver 272. This random function is used to generate a random index that can be use to shuffle the stream X[i]. That is, the stream Y[i] in FIG. 15 is the shuffled version of X[i] in a random manner.

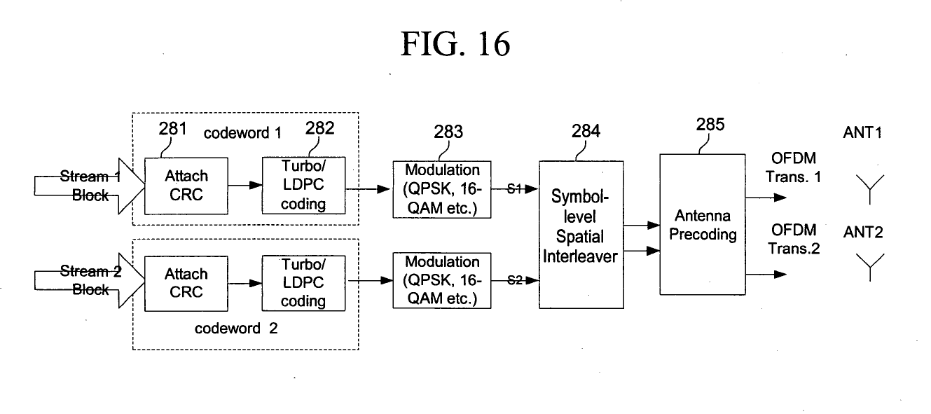

FIG. 16 illustrates a block diagram of another proposed spatial interleaver scheme (denoted as Scheme-C) for multi-codeword MIMO-OFDM systems according to a seventh embodiment of the principles of the present invention. As compared to the Scheme-A as shown in FIG. 8, the two channel bit interleavers 203 between the coding unit and the modulation unit are removed. Instead, Scheme-C provides less signal processing power consumption over Scheme-A at the expense of slight performance loss at a transmitter and a receiver.

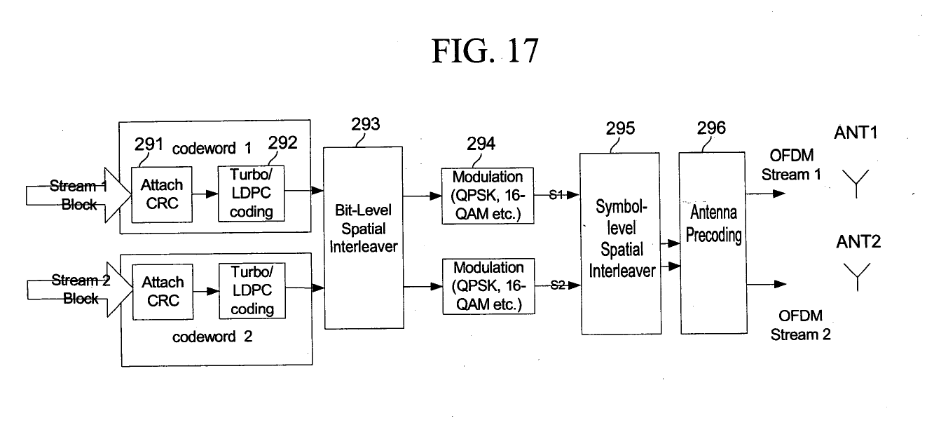

FIG. 17 illustrates a block diagram for another proposed spatial interleaver scheme (denoted as Scheme-D) for multi-codeword MIMO-OFDM systems according to an eighth embodiment of the principles of the present invention. In the Scheme-D, both symbol-level spatial interleaver 295 and bit-level spatial interleaver 293 are employed as shown in FIG. 17.

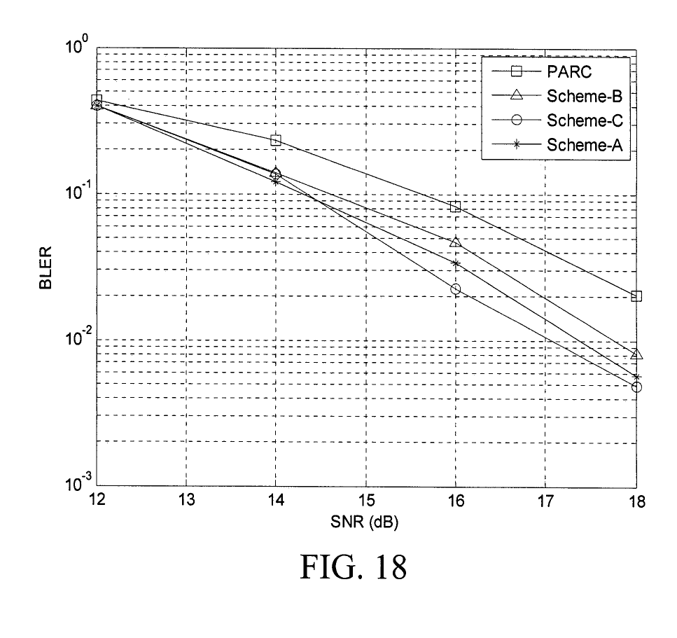

Hereinafter, we provide some simulation results that compare the performance among the proposed schemes. It is noted that the simulation is based on 3GPP/LTE frame format as well as its codeword generation. Spatial channel model (SCM) is used in the simulation. The MMSE (minimum mean square error) receiver is assumed in the simulation. FIG. 18 illustrates the block error rate (BLER) performance of the proposed schemes against prior art (PARC system) with QAM-16 modulation and Turbo coding with a coding rate of ½. These results show that all of the proposed schemes Scheme-A, Scheme-B, and Scheme-C outperform the PARC system.

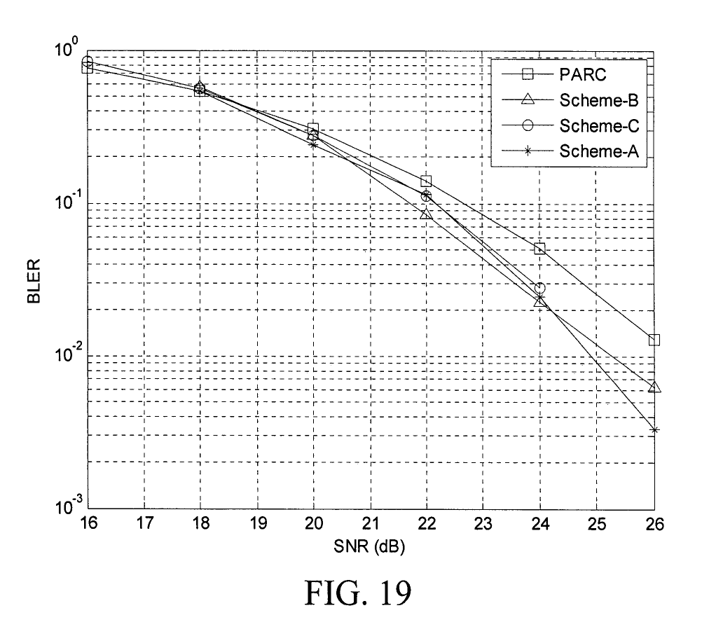

FIG. 19 illustrates the BLER performance of the proposed schemes against PARC system with QAM-64 modulation and Turbo coding with code rate ⅗. These results also show that the all of the proposed schemes Scheme-A, Scheme-B, and Scheme-C outperform the PARC system.

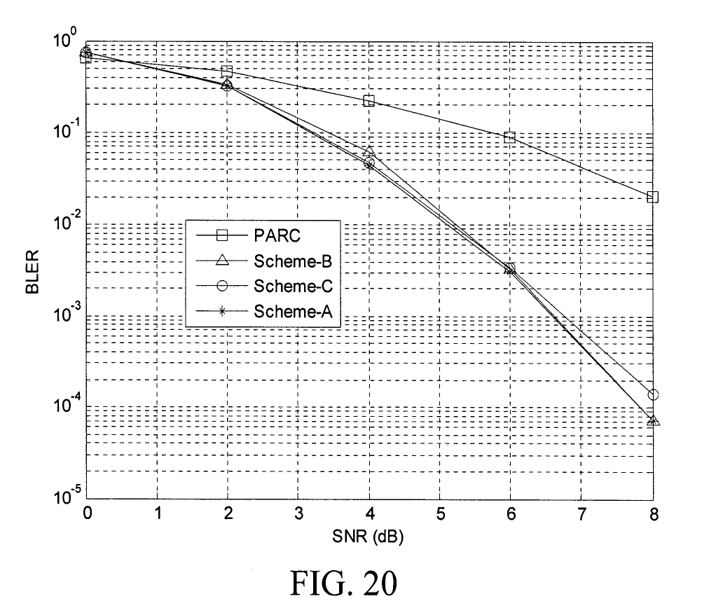

FIG. 20 illustrates the BLER performance of the proposed schemes against PARC system with QPSK modulation and Turbo coding with a coding rate ⅓. These results also show that the all of the proposed schemes Scheme-A, Scheme-B, and Scheme-C outperform the PARC system.

What is claimed is:

1. A method for transmission, the method comprising the steps of:
demultiplexing information to be transmitted into a plurality of stream blocks;
encoding each of the stream blocks according to a corresponding coding scheme to generate a plurality of encoded streams;
interleaving each of the encoded streams in a bit-level to generate a plurality of bit-level interleaved streams;
modulating each of the bit-level interleaved streams according to a corresponding modulation scheme to generate a plurality of modulated symbol streams;
interleaving the plurality of modulated symbol streams in a symbol-level to generate a plurality of symbol-level interleaved streams;
precoding the plurality of symbol-level interleaved streams according to a precoding scheme to generate a plurality of precoded streams; and
transmitting the plurality of precoded streams via a plurality of antennas.

2. The method of claim 1, comprised of the step of interleaving the plurality of modulated symbol streams in the symbol-level comprising:
multiplexing the plurality of modulated symbol streams to generate a single stream; and
equally dividing the single stream into the plurality of symbol-level interleaved streams, with the number of the plurality of symbol-level interleaved streams being equal to the number of the antennas for transmitting the streams.

3. The method of claim 1, comprised of the step of interleaving the plurality of modulated symbol streams in the symbol-level comprising:
multiplexing the plurality of modulated symbol streams to generate a single stream;
mapping the single stream into an N×M matrix in a column-wise manner, with each symbol in the single stream corresponding to one element in the N×M matrix, and B=N×M, where B is the number of the symbols in the single stream;
reading the symbols in the N×M matrix in a row-wise manner and concatenating the symbols to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

4. The method of claim 3, comprised of mapping in the column-wise manner being mapping from the top to the bottom in each column, and mapping in the row-wise manner being mapping from the right to the left in each row.

5. The method of claim 1, comprised of the step of interleaving the plurality of modulated symbol streams in the symbol-level comprising:
multiplexing the plurality of modulated symbol streams to generate a single stream;
mapping the single stream into an N×M matrix in a row-wise manner, with each symbol in the single stream corresponding to one element in the N×M matrix, and B=N×M, where B is the number of the symbols in the single stream;
reading the symbols in the N×M matrix in a column-wise manner and concatenating the symbols to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

6. The method of claim 1, comprised of the step of interleaving the plurality of modulated symbol streams in the symbol-level comprising:
multiplexing the plurality of modulated symbol streams to generate a single stream;
randomly rearranging the symbols in the single stream according to a random function to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

7. The method of claim 1, comprised of each of the encoded streams being interleaved in the bit-level by:
mapping the bits in the encoded stream into an N×M matrix in a column-wise manner, with each bit corresponding to one element in the N×M matrix, and B=N×M, where B is the number of the bits in the encoded stream;
reading the bits in the N×M matrix in a row-wise manner and concatenating the bits to generate a single bit-level interleaved stream.

8. The method of claim 1, comprised of each of the encoded streams being interleaved in the bit-level by:
mapping the bits in the encoded stream into an N×M matrix in a row-wise manner, with each bit corresponding to one element in the N×M matrix, and B=N×M, where B is the number of the bits in the encoded stream;
reading the bits in the N×M matrix in a column-wise manner and concatenating the bits to generate a single bit-level interleaved stream.

9. The method of claim 1, further comprising attaching an individual cyclic redundancy check to each of the stream blocks.

10. A method for transmission, the method comprising the steps of:
demultiplexing information to be transmitted into a plurality of stream blocks;
encoding each of the stream blocks according to a corresponding coding scheme to generate a plurality of encoded streams;
interleaving the plurality of encoded streams in a bit-level to generate a plurality of bit-level interleaved streams;
modulating each of the bit-level interleaved streams according to a modulation scheme to generate a plurality of modulated symbol streams;
precoding the plurality of modulated symbol streams according to a precoding scheme to generate a plurality of precoded streams; and
transmitting the plurality of precoded streams via a plurality of antennas.

11. The method of claim 10, comprised of the step of interleaving the plurality of encoded streams in the bit-level comprising:
multiplexing the plurality of encoded streams to generate a single stream; and
equally dividing the single stream into the plurality of bit-level interleaved streams, with the number of the plurality of bit-level interleaved streams being equal to the number of the antennas for transmitting the streams.

12. The method of claim 10, comprised of the step of interleaving the plurality of encoded streams in the bit-level comprising:
multiplexing the plurality of encoded streams to generate a single stream;
mapping the single stream into an N×M matrix in a column-wise manner, with each bit in the single stream corresponding to one element in the N×M matrix, arid B=N×M, where B is the number of the bits in the single stream;
reading the bits in the N×M matrix in a row-wise manner and concatenating the bits to generate a single bit-level interleaved stream; and
equally dividing the single bit-level interleaved stream into the plurality of bit-level interleaved streams, with the number of the plurality of bit-level interleaved streams being equal to the number of the antennas for transmitting the streams.

13. The method of claim 12, comprised of mapping in the column-wise manner being mapping from the top to the bottom in each column, and mapping in the row-wise manner being mapping from the right to the left in each row.

14. The method of claim 10, comprised of the step of interleaving the plurality of encoded streams in the bit-level comprising:
multiplexing the plurality of encoded streams to generate a single stream;
mapping the single stream into an N×M matrix in a row-wise manner, with each bit in the single stream corresponding to one element in the N×M matrix, and B=N×M, where B is the number of the bits in the single stream;
reading the bits in the N×M matrix in a column-wise manner and concatenating the bits to generate a single bit-level interleaved stream; and
equally dividing the single bit-level interleaved stream into the plurality of bit-level interleaved streams, with the number of the plurality of bit-level interleaved streams being equal to the number of the antennas for transmitting the streams.

15. The method of claim 10, comprised of the step of interleaving the plurality of encoded streams in the bit-level comprising:
multiplexing the plurality of encoded streams to generate a single stream;
randomly rearranging the bits in the single stream according to a random function to generate a single bit-level interleaved stream; and
equally dividing the single bit-level interleaved stream into the plurality of bit-level interleaved streams, with the number of the plurality of bit-level interleaved streams being equal to the number of the antennas for transmitting the streams.

16. The method of claim 10, further comprising attaching an individual cyclic redundancy check to each of the stream blocks.

17. A method for transmission, the method comprising the steps of:
demultiplexing information to be transmitted into a plurality of stream blocks;
encoding each of the stream blocks according to a corresponding coding scheme to generate a plurality of encoded streams;
modulating each of the encoded streams according to a corresponding modulation scheme to generate a plurality of modulated symbol streams;
interleaving the plurality of modulated symbol streams in a symbol-level to generate a plurality of symbol-level interleaved streams;
precoding the plurality of symbol-level interleaved streams according to a precoding scheme to generate a plurality of precoded streams; and
transmitting the plurality of precoded streams via a plurality of antennas.

18. The method of claim 17, comprised of the step of interleaving the plurality of modulated symbol streams in the symbol-level comprising:
multiplexing the plurality of modulated symbol streams to generate a single stream; and
equally dividing the single stream into the plurality of symbol-level interleaved streams, with the number of the plurality of symbol-level interleaved streams being equal to the number of the antennas for transmitting the streams.

19. The method of claim 17, comprised of the step of interleaving the plurality of modulated symbol streams in the symbol-level comprising:
multiplexing the plurality of modulated symbol streams to generate a single stream;
mapping the single stream into an N×M matrix in a column-wise manner, with each symbol in the single stream corresponding to one element in the N×M matrix, and B=N×M, where B is the number of the symbols in the single stream;
reading the symbols in the N×M matrix in a row-wise manner and concatenating the symbols to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

20. The method of claim 19, comprised of mapping in the column-wise manner being mapping from the top to the bottom in each column, and mapping in the row-wise manner being mapping from the right to the left in each row.

21. The method of claim 17, comprised of the step of interleaving the plurality of modulated symbol streams in the symbol-level comprising:
multiplexing the plurality of modulated symbol streams to generate a single stream;
mapping the single stream into an N×M matrix in a row-wise manner, with each symbol in the single stream corresponding to one element in the N×M matrix, and B=N×M, where B is the number of the symbols in the single stream;
reading the symbols in the N×M matrix in a column-wise manner and concatenating the symbols to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

22. The method of claim 17, comprised of the step of interleaving the plurality of modulated symbol streams in the symbol-level comprising:
multiplexing the plurality of modulated symbol streams to generate a single stream;
randomly rearranging the symbols in the single stream according to a random function to generate a single symbol-level interleaved stream; and
equally dividing the single symbol-level interleaved stream into the plurality of symbol-level interleaved streams, with the number-of the plurality of symbol-level interleaved streams being equal to the number of the antennas for transmitting the streams.

23. The method of claim 17, further comprising attaching an individual cyclic redundancy check to each of the stream blocks.

24. A method for transmission, the method comprising the steps of:
demultiplexing information to be transmitted into a plurality of stream blocks;
encoding each of the stream blocks according to a corresponding coding scheme to generate a plurality of encoded streams;
interleaving the plurality of encoded streams in a bit-level to generate a plurality of bit-level interleaved streams;
modulating each of the bit-level interleaved streams according to a corresponding modulation scheme to generate a plurality of modulated symbol streams;
interleaving the plurality of modulated symbol streams in a symbol-level to generate a plurality of symbol-level interleaved streams;
precoding the plurality of symbol-level interleaved streams according to a precoding scheme to generate a plurality of precoded streams; and
transmitting the plurality of precoded streams via a plurality of antennas.

25. The method of claim 24, comprised of the step of interleaving the plurality of encoded streams in the bit-level comprising:
multiplexing the plurality of encoded streams to generate a single stream; and
equally dividing the single stream into the plurality of bit-level interleaved streams, with the number of the plurality of bit-level interleaved streams being equal to the number of the antennas for transmitting the streams.

26. The method of claim 24, comprised of the step of interleaving the plurality of encoded streams in the bit-level comprising:
multiplexing the plurality of encoded streams to generate a single stream;
mapping the single stream into an N×M matrix in a column-wise manner, with each bit in the single stream corresponding to one element in the N×M matrix, and B=N×M, where B is the number of the bits in the single stream;
reading the bits in the N×M matrix in a row-wise manner and concatenating the bits to generate a single bit-level interleaved stream; and
equally dividing the single bit-level interleaved stream into the plurality of bit-level interleaved streams, with the number of the plurality of bit-level interleaved streams being equal to the number of the antennas for transmitting the streams.

27. The method of claim 26, comprised of mapping in the column-wise manner being mapping from the top to the bottom in each column, and mapping in the row-wise manner being mapping from the right to the left in each row.

28. The method of claim 24, comprised of the step of interleaving the plurality of encoded streams in the bit-level comprising:
multiplexing the plurality of encoded streams to generate a single stream;
mapping the single stream into an N×M matrix in a row-wise manner, with each bit in the s single stream corresponding to one element in the N×M matrix, and B=N×M, where B is the number of the bits in the single stream;
reading the bits in the N×M matrix in a column-wise manner and concatenating the bits to generate a single bit-level interleaved stream; and
equally dividing the single bit-level interleaved stream into the plurality of bit-level interleaved streams, with the number of the plurality of bit-level interleaved streams being equal to the number of the antennas for transmitting the streams.

29. The method of claim 24, comprised of the step of interleaving the plurality of encoded streams in the bit-level comprising:
multiplexing the plurality of encoded streams to generate a single stream;
randomly rearranging the bits in the single stream according to a random function to generate a single bit-level interleaved stream; and
equally dividing the single bit-level interleaved stream into the plurality of bit-level interleaved streams, with the number of the plurality of bit-level interleaved streams being equal to the number of the antennas for transmitting the streams.

30. The method of claim 24, comprised of the step of interleaving the plurality of modulated symbol streams in the symbol-level comprising:
multiplexing the plurality of modulated symbol streams to generate a single stream; and
equally dividing the single stream into the plurality of symbol-level interleaved streams, with the number of the plurality of symbol-level interleaved streams being equal to the number of the antennas for transmitting the streams.

31. The method of claim 24, comprised of the step of interleaving the plurality of modulated symbol streams in the symbol-level comprising:
multiplexing the plurality of modulated symbol streams to generate a single stream;
mapping the single stream into an N×M matrix in a column-wise manner, with each symbol in the single stream corresponding to one element in the N×M matrix, and B=N×M, where B is the number of the symbols in the single stream;
reading the symbols in the N×M matrix in a row-wise manner and concatenating the symbols to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

32. The method of claim 31, comprised of mapping in the column-wise manner being mapping from the top to the bottom in each column, and mapping in the row-wise manner being mapping from the right to the left in each row.

33. The method of claim 24, comprised of the step of interleaving the plurality of modulated symbol streams in the symbol-level comprising:
multiplexing the plurality of modulated symbol streams to generate a single stream;
mapping the single stream into an N×M matrix in a row-wise manner, with each symbol in the single stream corresponding to one element in the N×M matrix, and B=N×M, where B is the number of the symbols in the single stream;
reading the symbols in the N×M matrix in a column-wise manner and concatenating the symbols to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

34. The method of claim 24, comprised of the step of interleaving the plurality of modulated symbol streams in the symbol-level comprising:
multiplexing the plurality of modulated symbol streams to generate a single stream;
randomly rearranging the symbols in the single stream according to a random function to generate a single symbol-level interleaved stream; and
equally dividing the single symbol-level interleaved stream into the plurality of symbol-level interleaved streams, with the number of the plurality of symbol-level interleaved streams being equal to the number of the antennas for transmitting the streams.

35. The method of claim 24, further comprising attaching an individual cyclic redundancy check to each of the stream blocks.

36. A transmitter, comprising:
a demultiplexer demultiplexing information to be transmitted into a plurality of stream blocks;
a plurality of cyclic redundancy check insertion units respectively inserting respective cyclic redundancy checks to the corresponding stream blocks;
a plurality of encoding units respectively encoding corresponding ones of the stream blocks according to corresponding coding schemes to generate a plurality of encoded streams;
a bit-level spatial interleaver interleaving the plurality of encoded streams in a bit-level to generate a plurality of bit-level interleaved streams;
a plurality of modulators modulating respectively corresponding ones of the bit-level interleaved streams according to corresponding modulation schemes to generate a plurality of modulated symbol streams;
a preceding unit precoding the plurality of modulated symbol streams according to a precoding scheme to generate a plurality of precoded streams; and
a plurality of antennas for transmitting the plurality of precoded streams.

37. The transmitter of claim 36, further comprising a symbol-level spatial interleaver coupled between the plurality of modulators and the preceding unit to interleave the plurality of modulated symbol streams in a symbol-level.

38. A transmitter, comprising:
a demultiplexer demultiplexing information to be transmitted into a plurality of stream blocks;
a plurality of cyclic redundancy check insertion units respectively inserting respective cyclic redundancy checks to the corresponding stream blocks;
a plurality of encoding units respectively encoding corresponding ones of the stream blocks according to corresponding coding schemes to generate a plurality of encoded streams;
a plurality of modulators modulating respectively corresponding ones of the encoded streams according to corresponding modulation schemes to generate a plurality of modulated symbol streams;
a symbol-level spatial interleaver interleaving the plurality of modulated symbol streams in a symbol-level to generate a plurality of symbol-level interleaved streams;
a precoding unit precoding the plurality of symbol-level interleaved streams according to a precoding scheme to generate a plurality of precoded streams; and
a plurality of antennas for transmitting the plurality of precoded streams.

39. The transmitter of claim 38, further comprising a plurality of channel bit interleavers coupled between the plurality of encoding units and the plurality of modulators to respectively interleave corresponding ones of the encoded streams in a bit-level.
